(19) United States
(12) Patent Application Publication
(10) Pub. No.: US 2022/0324729 A1
(43) Pub. Date: Oct. 13, 2022

(54) ELECTROCHEMICAL METHOD FOR OXIDATION OF ORGANIC COMPOUNDS IN AQUEOUS SOLUTIONS AND REDUCTION OF BY-PRODUCTS

(71) Applicant: University of Washington, Seattle, WA (US)

(72) Inventors: Hugh W. Hillhouse, Seattle, WA (US); James A. Clark, Seattle, WA (US)

(73) Assignee: University of Washington, Seattle, WA (US)

(21) Appl. No.: 17/641,599

(22) PCT Filed: Sep. 11, 2020
(86) PCT No.: PCT/US2020/050433

§ 371 Date: Mar. 9, 2022

Related U.S. Application Data
(60) Provisional application No. 62/899,583, filed on Sep. 12, 2019.

(51) Int. Cl. C02F 1/467; C02F 1/461

(52) U.S. Cl. CPC C02F 1/4672; C02F 1/4676; C02F 1/46109; C02F 2201/46115; C02F 2001/46147; C02F 2103/005

(57) ABSTRACT

Methods for electrochemically oxidizing organic compounds in aqueous solution. The methods include contacting an aqueous solution comprising organic compounds with a first anode and electrochemically oxidizing at least a portion of the organic compounds to provide a first aqueous solution comprising oxidation products; and contacting the first aqueous solution comprising oxidation products with a first cathode and electrochemically reducing at least a portion of the oxidation products to provide a first aqueous solution comprising reduced products and residual oxidizable organic compounds. The first aqueous solution can be further treated to electrochemically oxidize at least a portion of the residual oxidizable organic compounds to provide a second aqueous solution comprising oxidation products, and the second aqueous solution can be further treated to electrochemically reduce at least a portion of the oxidation products to provide a third aqueous solution comprising reduced products and residual oxidizable organic compounds. Systems for electrochemically oxidizing organic compounds and effectively carrying out the methods are also provided.

### CROSS-REFERENCE TO RELATED APPLICATION

This application claims the benefit of U.S. Application No. 62/899,583, filed Sep. 12, 2019, expressly incorporated herein by reference in its entirety.

### BACKGROUND OF THE INVENTION

Most pharmaceutical compounds are not sufficiently deactivated at wastewater treatment facilities (WWTFs) (utilizing biological treatment, electrocoagulation, coagulation and membrane filtration processes) and eventually end up being discharged into the environment. These pharmaceuticals threaten aquatic ecosystems, contribute to bacterial drug resistance, and eventually return to human drinking water supplies.

One recent study of biologically active pollutants in Puget Sound estuaries found forty-two (42) compounds in the tissue of whole-body juvenile Chinook salmon, including high concentrations of amphetamines (ADDERALL® and other drugs for ADD and recreational abuse), fluoxetine (PROZAC® antidepressant), and sertraline (ZOLOFT® anti-depressant). Most pharmaceutical compounds are typically non-lethal to organisms, but they do change behavior. The impact of this is hard to estimate (or even fully understand), but the effects are certain to ripple through the ecosystem placing additional stress on already fragile populations. The problem is big and growing, and it is both scientifically and economically challenging to treat large volumes of WWTP effluent that are polluted with dilute concentrations of 1,000+ chemically different compounds.

Advanced oxidation processes (AOPs) are an attractive technology to address this growing problem because of their ability to degrade most organic species via the in-situ generation of oxidizing species (e.g., OH, H₂O₂, O₂, O₃, HOCl), which can be generated through photochemical or electrochemical means. The dominant route for pharmaceutical excretion is in urine; therefore, decentralized AOPs, which treat this concentrated source of pharmaceuticals before it is diluted with other wastewater streams, would allow for much higher efficiency toward pharmaceutical degradation. Multiple studies have examined pharmaceutical degradation using AOPs for over a decade, but recent works have highlighted that toxic byproducts (TBPs) (e.g., chlorate, perchlorate, haloacetic acids, aliphatic halides species, haloacetonitriles, and haloacetamides) formed during AOPs compromise the quality of the treated effluent. These TBPs are mostly chlorinated species; however, brominated and iodinated species may be present at much lower concentrations but with higher toxicity. Of the toxic byproducts, ClO₄⁻ is perhaps the biggest problem due to its exceptionally high stability and low toxicity threshold. Thus, there is a need to develop novel AOPs that have high efficiency toward pharmaceutical reduction to prevent or mitigate ClO₄⁻ formation.

Multiple studies have examined the electrochemical oxidation of simulated fresh urine, stored urine, or simulated stored urine. Though the details used in these studies vary significantly, there are examples where the concentrations of generated ClO₄⁻ for roughly equivalent oxidation treatments are vastly different. For a normalized charge passed of 30 Ahrs/L, two studies report 100% oxidation of chloride to ClO₄⁻, while another reports ClO₄⁻ below the detection limit. One big difference between these studies is the composition of the matrix. Urine has a high concentration of nitrogen of about 10 g/L, which is bound in the form of urea. However, natural abundant bacterial urease hydrolyzes urea to form ammonium, bicarbonate, and OH⁻. This reaction happens rapidly, with one study finding that urea is nearly completely hydrolyzed within 5 hours of storage in a pipe. The dissolved ammonium is in equilibrium with dissolved ammonia, which is volatile and will evaporate over time if exposed to open air.

In separate literature, electrochemical reduction of has been demonstrated for various toxic byproducts, including aliphatic chlorides, haloacetic acids, nitrosamines, ClO₃⁻, and ClO₄⁻. Generally, the electrochemical reduction of these species is favored at low pH. Of all of these TBPs ClO₄⁻ has the slowest reduction rate, because of its exceptionally large reduction activation barrier of 120 kJ/mole. A recent review on the electrocatalytic reduction of ClO₄⁻ identified three possible mechanisms for the electrocatalytic reduction of ClO₄⁻: (1) electrocatalysis, (2) hydrodeoxygenation, and (3) multivalent titanium ion reduction.

Despite the advances in the electrochemical degradation of organic compounds such as pharmaceuticals, a need exists for improved methods that not only effectively degrade these compounds but further limit the production of toxic byproducts. The present seeks to fulfill this need and provides further related advantages.

### SUMMARY OF THE INVENTION

In one aspect of the invention, methods for electrochemically oxidizing organic compounds are provided.

In one embodiment, the method comprises:

(a) contacting an aqueous solution comprising organic compounds with a first anode and electrochemically oxidizing at least a portion of the organic compounds to provide a first aqueous solution comprising oxidation products; and

(b) contacting the first aqueous solution comprising oxidation products with a first cathode and electrochemically reducing at least a portion of the oxidation products to provide a first aqueous solution comprising reduced products and residual oxidizable organic compounds.

In certain of these embodiments, the methods further comprise contacting the first aqueous solution comprising reduced products and residual oxidizable organic compounds with a second anode and electrochemically oxidizing at least a portion of the residual oxidizable organic compounds to provide a second aqueous solution comprising oxidation products. In certain embodiments, the second anode is the same as (e.g., recycle process) or different from (e.g., multiple anode configuration) from the first anode.

In certain of these embodiments, the methods further comprise contacting the second aqueous solution comprising oxidation products with a second cathode and electrochemically reducing at least a portion of the oxidation products to provide a third aqueous solution comprising reduced products and residual oxidizable organic compounds. In certain embodiments, the second cathode is the same as (e.g., recycle process) or different from (e.g., multiple cathode configuration) the first cathode.

In another aspect, the invention provides systems and devices having a variety of electrode configurations effective to carry out the methods described herein.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIGS. 1A and 1B compares concentrations of generated ClO₃⁻ (FIG. 1A) and ClO₄ (FIG. 1B) for various matrices oxidized on a BDD anode. Recommended drinking water maximum concentrations are 90 ppb for ClO₄⁻ and 200 ppb for ClO₃⁻. Concentrations for 100× drinking water correspond to typical dilution from other domestic wastewater. Galvanostatic treatments were performed for 90 mins at a current density of 94 mA/cm² for a final charge passed of 30 Ahrs/L. Matrices with high nitrogen content corresponding to the concentration of fresh urine (250 mM urea or 500 mM NH₄⁺) show a three order of magnitude suppression in the generated ClO₃⁻ and ClO₄⁻ compared to a nitrogen free matrix.

FIGS. 2A and 2B show cyclic voltammograms (CVs) of 0.1 M NaClO₄, 0.1 M NaCl, and 0.1M NaCl+0.25 M urea on BDD (FIG. 2A) and IrO₂ (FIG. 2B) anodes. The CV of 0.1 M NaCl oxidized on BDD exhibits an oxidation peak with is attributed to the oxidation of HOCl. This peak is absent in 0.1 M NaCl+0.25 M urea CV, which suggests that urea scavenges HOCl. A similar phenomenon is observed in the IrO₂ CVs where the HOCl reduction peak is apparent in the 0.1 M NaCl matrix and absent from the 0.1 M NaCl+0.25 M Urea matrix.

FIGS. 3A and 3B show schematic illustrations of non-divided (3A) and divided (3B) cell configurations for oxidation. For the divided cell setup, a glass frit (with porosity 4-8 um) proved to be a simple way to prevent mixing of solutions in the anode and cathode compartments. Furthermore, this led to large pH difference between the two compartments as shown in FIG. 3C.

FIGS. 4A-4C compare results from oxidation experiments of a simple urine matrix spiked with a pharmaceutical at 10 mA/cm² on BDD and IrO₂ anodes in the undivided and divided setups (120 mins of oxidation corresponds to 4.28 Ahrs/L): concentration of cyclophosphamide (CP) over the course of the oxidation with a starting CP concentration of 500 ppm (FIG. 4A) (inset shows the chemical structure of CP); concentration of sulfamethoxazole (SMX) over the course of the oxidation with a starting SMX concentration of 100 ppm (FIG. 4B) (inset shows the chemical structure of SMX); and the observed first-order rate constants for pharmaceutical degradation (FIG. 4C).

FIGS. 5A-5J compare the concentrations of ClO₄ (FIGS. 5A and 5B), ClO₃⁻, (FIGS. 5C and 5D), NO₃⁻ (FIGS. 5E and 5F), NO₂⁻ (FIGS. 5G and 5H), and dissolved oxidants (FIGS. 5I and 5J) measured over the course of two hours of oxidation at 10 mA/cm² on BDD and IrO₂ anodes in the undivided and divided setups. 120 mins of oxidation corresponds to 4.28 A·hrs/L. Results from oxidation of simple urine matrix with 500 ppm CP (FIGS. 5A, 5C, 5E, 5G, and SI). Results from oxidation of simple urine matrix with 100 ppm SMX (FIGS. 5B, 5D, 5F, 5H, and 5J). Dissolved oxidants were quantified SO₄²⁻ by spiking samples taken for IC with Na₂S₂O₃.

FIGS. 6A-6F compares cyclic voltammograms (CVs) for various matrixes on Pt (6A, 6D), Mo (6B, 6E), and Ti (6E, 6F) cathodes at pH=7 (6A-6C) and pH=2 (6D-6F). A comparison of the potential required for the HER indicates the cathodes have an increasing kinetic barrier to the HER in order of Ti>Mo>Pt. CV of 0.1 M NaClO₃ and 0.1 M NaClO₄ at pH 7 show no substantial reduction peaks associated with ClO₃⁻ and ClO₄⁻, suggesting that low pH is required for these reduction reactions to occur at significant rates. CV of 0.1 M NaClO₃ and 0.1 M NaClO₄ at pH 2 indicate reduction peaks corresponding to ClO₃⁻ and ClO₄⁻ reduction for all cathodes. Lower pH increases the formal potential (driving force) for reduction of ClO₃⁻ and ClO₄⁻.

FIG. 7A is a schematic illustration of a reducing divided cell setup. Results of reduction experiments performed on Ti, Mo, and Pt cathodes in the reducing divided cell setup, where cathodes were held at the indicated voltages for 3 hours. The initial concentrations of ClO₃⁻ and ClO₄⁻ were 30 ppm and 5 ppm respectively, and initial pH was 2.00. This composition is similar to the composition after 120 mins of oxidation in the divided cell setup. Final pH of the cathodic solutions (FIGS. 7B and 7C) (high final pH is indicative of the hydrogen evolution reaction. First-order degradation rate constants for ClO₃⁻ (FIG. 7C) and ClO₄ (FIG. 7D). These data indicate that ClO₃⁻ and ClO₄⁻ can be reduced.

FIG. 8A is a raw ion-chromatography data for (1) simple urine matrix with 500 ppm CP before oxidation, (2) after oxidation on BDD at 10 mA/cm² for 120 minutes (4.28 A·hrs/L) in divided cell set-up, and (3) after a subsequent reduction on Ti at −850 mV for 480 mins. Normalized concentration of various anions during the oxidation and the subsequent reduction (FIG. 8B). These data illustrate the potential of a post-oxidation reduction treatment to remediate ClO₃⁻ and ClO₄⁻.

FIGS. 9A and 9B are schematic illustrations of devices for oxidizing organic compounds (e.g., pharmaceuticals) in fresh human urine, while eliminating all TBPs. In both schemes, the urine is first split into an anode compartment (90%) and a cathode compartment (10%) with a porous glass frit. An electrochemical treatment is applied such that all pharmaceuticals oxidized, some TBPs are generated, and the pH is lowered in the anode compartment. After a treatment to reduce TBPs, separated solutions are mixed (neutralizing the pH) and recycled to oxidize pharmaceuticals originally in the cathode compartment (10%). After 4 cycles the pharmaceuticals are at 0.01% of their original concentration and are sent to waste. In FIG. 9A the liquid in the anode and cathode compartments of the first divided cell is respectively sent to a cathode and anode compartment of a second divided cell. A low voltage reduction treatment is applied to the low pH solution containing TBPs in the cathode compartment, while the anode generates O₂ gas and minimal TBPs. In FIG. 9B the liquid in the anode compartment of the first divided cell is sent to a second cell which is targeted to maximize the rate of ClO₄⁻ reduction. Low pH increases the rate of reduction on the cathode surface, a sacrificial Ti anode is chosen to generate multivalent titanium ions to reduce ClO₄⁻, and H₂ gas recycled from the cathode compartment of the first divided cell also reduce ClO₄ via hydrodeoxygenation.

FIG. 10A is a schematic illustration of a representative electrochemical urine treatment devices: simplest possible device with a single anode and cathode in a planar arrangement with an applied DC voltage. In this embodiment, the urine can be gravity fed into the gap and exited at the bottom at a fixed rate requiring no moving parts. FIG. 10B is a cross-sectional view of a representative device to illustrate representative electrode sequencing schemes. The number of anode/cathode segments, the length of each segment, and even the composition of each anode and cathode can be varied as a function of position to maximize pharmaceutical degradation and minimize TBP formation. The alternation of anode and cathode on a single plate sequentially exposes the part of the solution that was just oxidized to a region to be reduced, without needing to stir the solution, ameliorating mass transport issues. FIG. 10C is a plan-view of one side of a plate with many anode and cathode sections interdigitated, yielding easy electrical connection. FIG. 10D is a schematic illustration of “molecular shredding” showing a cyclophosphamide (CP) chemotherapy drug (with urea, chloride, and water) shredded into smaller fragments without over-oxidation and halogenation to form perchlorate and trihalomethane toxic by-products.

### DETAILED DESCRIPTION OF THE INVENTION

The present invention provides systems and methods for in-situ electrochemical reduction of toxic byproducts (TBPs) after the application of an advanced oxidation processes (AOP).

The present invention provides two important advances in field of advanced oxidation processes for wastewater treatment. First, the present invention reveals the beneficial effects of high ammonia content to prevent the generation of perchlorate and chlorate. In certain embodiments, the invention provides systems and methods for immediately treating contaminated urine at the source of generation. Second, in certain embodiments, the invention provides electrochemical systems and methods based on divided cells using inexpensive glass frits. As a result, acidification of the oxidized matrix can be advantageously used for a subsequent reduction treatment to reduce toxic byproducts.

Disclosed herein is an electrochemical systems and methods to sequentially and/or repeatedly oxidize and reduce liquid waste streams that contain molecular pollutants or organisms. The process of organic compound degradation can be thought of as “molecular shredding” to chop-up molecules and reduce their biological activity without creating significant concentrations of toxic byproducts.

In one embodiment, the invention provides system and methods for point-source treatment of pharmaceutical compounds in human urine, before the massive dilution that occurs in-route to wastewater treatment facilities (WWTFs). Devices utilizing the technology are inexpensive, energy efficient, easy to operate, avoid the use of corrosive additives, and do not create significant toxic byproducts. This enables implementation in homes, hospitals, or other locations without the need for specialized assistance for operation or maintenance. The application of the technology extends beyond the destruction of pharmaceutical compounds in urine. Further applications include: (1) treatment of WWTF effluent to remove pharmaceuticals as a polishing step; (2) treatment of cargo-ship ballast water in-situ during its journey to disinfect the water and prevent the spread of invasive organisms across the globe; (3) destruction of polychlorinated biphenyls (PCBs) in groundwater; (4) treatment of drinking water at the time and point of use; and (5) de-toxification of an organic contaminant from an industrial or commercial site before discharge into the environment or discharge into the sewer.

Electrochemical Methods

In one aspect of the invention, methods for electrochemically oxidizing organic compounds are provided.

In one embodiment, the method comprises:

(a) contacting (e.g., flowing) an aqueous solution comprising organic compounds with a first anode and electrochemically oxidizing at least a portion of the organic compounds to provide a first aqueous solution comprising oxidation products; and

(b) contacting (e.g., flowing) the first aqueous solution comprising oxidation products with a first cathode and electrochemically reducing at least a portion of the oxidation products to provide a first aqueous solution comprising reduced products and residual oxidizable organic compounds.

The oxidation products of the methods of the invention include the oxidized organic compounds (e.g., oxidatively degraded organic compounds, such as shredded pharmaceuticals) and chlorine-based oxidation products. The oxidation products include inorganic oxidation products, e.g., Cl⁻ oxidation products.

The reduced products of the methods of the invention include the reduction products derived from the chlorine-based oxidation products (e.g., to prevent formation of TBP, such as perchlorate and trichloromethane). In certain aqueous media (e.g., urine) a main mechanism of action is oxidation of chloride (Cl⁻), which forms active chlorine species that then oxidize organic compounds in solution homogeneously (as opposed to heterogeneous oxidation on the electrode surface).

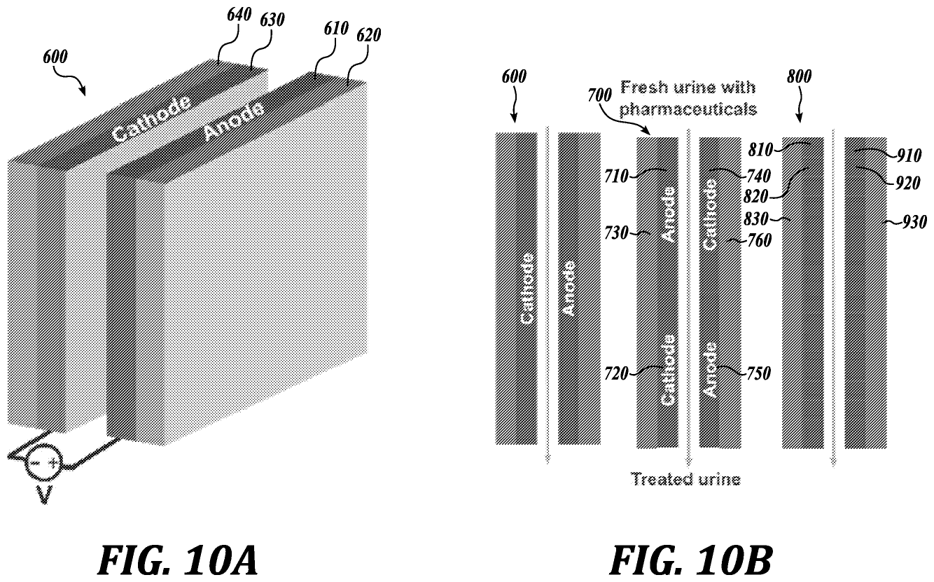

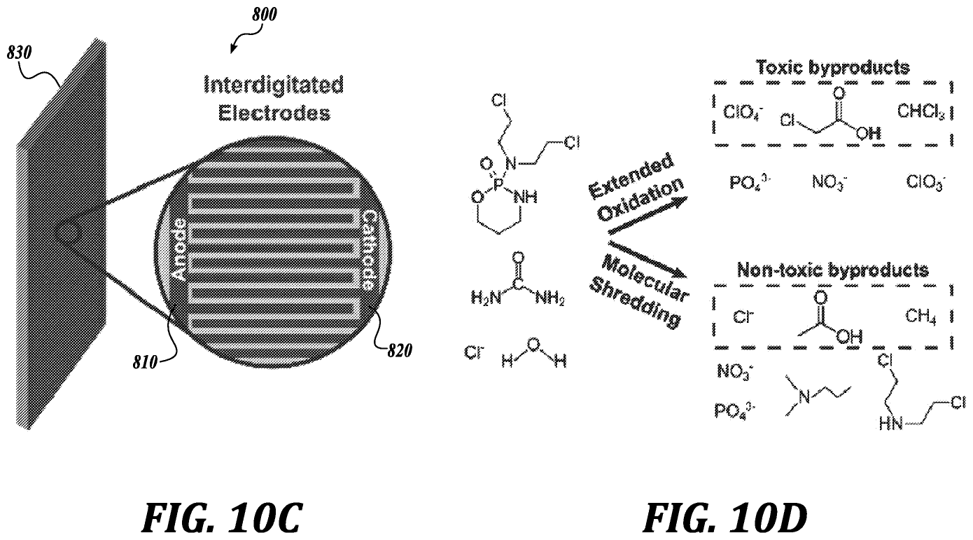

In the methods of the invention, the aqueous solutions are contacted with either the anode or cathode. In certain embodiments, the aqueous solutions flow from one electrode to the next. See, for example, FIG. 10B (second and third embodiments) and 10C.

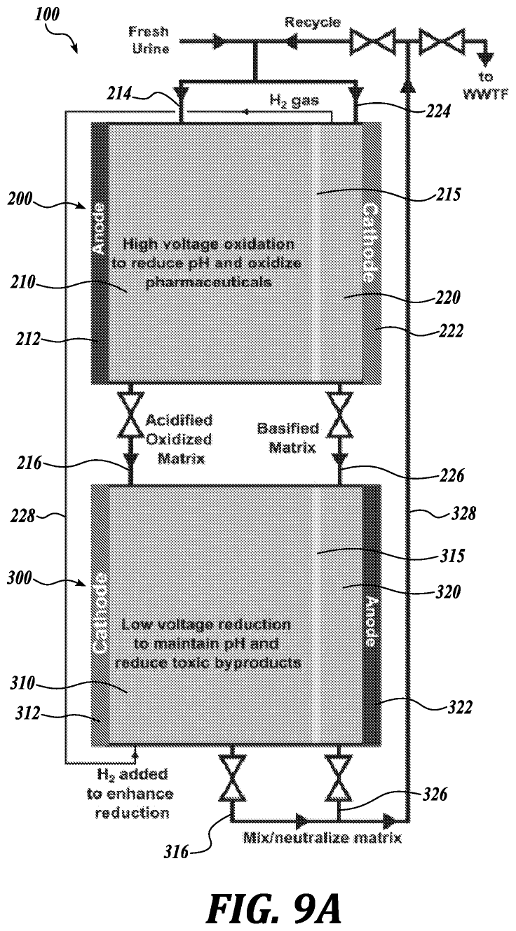

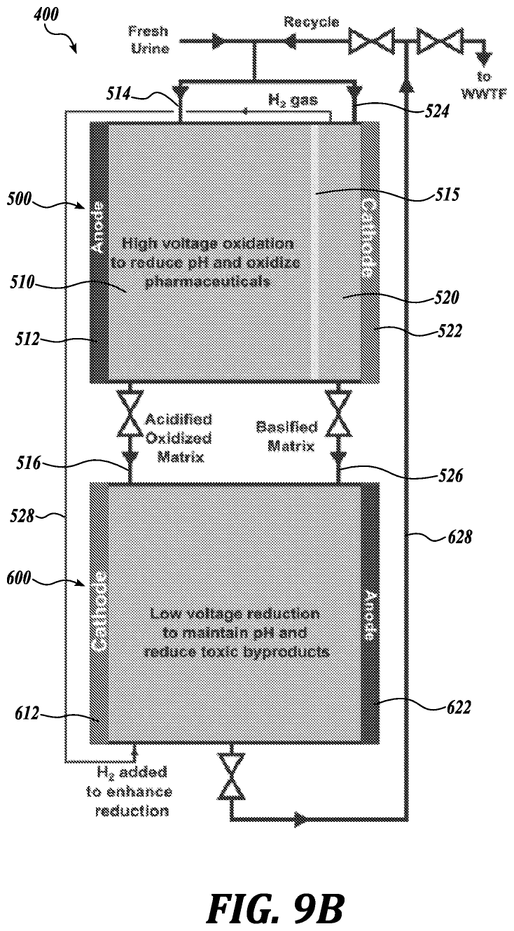

In the methods of the invention, first aqueous solution comprising oxidation products also includes organic compounds that have not been oxidized (i.e., residual oxidizable organic compounds). That is, in the methods only a portion of the organic compounds are oxidized in step (a) (i.e., first contact with the anode), and that in order to fully degrade (or shred) the organic compounds repetition is required to achieve the desired levels of residual organic compounds (e.g., recycle the solution of partially degraded organic compounds to the first anode or conduct (e.g., flow) the solution of partially degraded organic compounds to a second anode). Representative methods of recycling to the first anode are shown in FIGS. 9A and 9B. Representative methods of conducting the solution to a second anode are shown in FIG. 10B. In certain embodiments, the solution of partially degraded organic compounds is contacted with (e.g., flows over) a multiple electrode configuration. See, for example, FIG. 10C.

Likewise, the first aqueous solution comprising reduced products—the product of step (b)—also includes organic compounds that have not been oxidized (i.e., residual oxidizable organic compounds)—and further electrochemical oxidative action is required to lower ultimate level of organic compounds in effluent.

As noted above, in certain embodiments, the solution of partially degraded organic compounds is subject to a second cycle of oxidation/reduction.

In certain of these embodiments, the methods further comprise contacting (e.g., flowing) the first aqueous solution comprising reduced products and residual oxidizable organic compounds with a second anode and electrochemically oxidizing at least a portion of the residual oxidizable organic compounds to provide a second aqueous solution comprising oxidation products. In certain embodiments, the second anode is the same as (e.g., recycle process) or different from (e.g., multiple anode configuration) from the first anode.

In certain of these embodiments, the methods further comprise contacting (e.g., flowing) the second aqueous solution comprising oxidation products with a second cathode and electrochemically reducing at least a portion of the oxidation products to provide a third aqueous solution comprising reduced products and residual oxidizable organic compounds. In certain embodiments, the second cathode is the same as (e.g., recycle process) or different from (e.g., multiple cathode configuration) the first cathode.

In another embodiment, the invention provides a method for electrochemically oxidizing organic compounds as schematically shown in FIG. 9A. Referring to FIG. 9A, the invention provides a method for electrochemically oxidizing organic compounds, comprising:

(a) electrochemically oxidizing at least a portion of organic compounds in an aqueous solution in a first divided cell having a first anode compartment separated from a first cathode compartment by a porous membrane to provide a first aqueous solution comprising oxidation products;

(b) conducting the first aqueous solution comprising oxidation products to a second divided cell having a second anode compartment separated from a second cathode compartment by a porous membrane; and

(c) electrochemically reducing at least a portion of the oxidation products in the second divided cell to provide an aqueous solution comprising reduced products.

In certain of these embodiments, the aqueous solution of reduced products comprises residual oxidizable organic compounds and is conducted (e.g., recycled) to the first divided cell and at least a portion of the residual oxidizable organic compounds are electrochemically oxidized to provide a second aqueous solution comprising oxidation products.

In certain of these embodiments, the second aqueous solution comprising oxidation products and is conducted to the second divided cell and at least a portion of the oxidation products are electrochemically reduced to provide a second aqueous solution comprising reduced products.

It will be appreciated that the methods do not require the use of a porous membrane (e.g., a divided cell) is not required, but may be useful in order to swing the pH by H⁺ and OH⁻ generation on the anode and cathode, respectively.

In certain embodiments, the first aqueous solution comprising oxidation products from the anode compartment of the first divided cell is conducted to the cathode compartment of the second divided cell and the first aqueous solution comprising oxidation products from the cathode compartment of the first divided cell is conducted to the anode compartment of the second divided cell. In certain of these embodiments, the first aqueous solution comprising oxidation products conducted to the cathode compartment of the second divided cell and the first aqueous solution comprising oxidation products conducted to the anode compartment of the second divided cell are reduced to provide a second aqueous solution comprising reduced products. In certain of these embodiments, the second aqueous solution comprising reduced products and residual oxidizable organic compounds are conducted from the cathode and anode compartments of the second divided cell to the first divided cell for further oxidation. In certain embodiments, hydrogen generated in the cathode compartment of the first cell is conducted to the second cell to enhance reduction.

In another embodiment, the invention provides a method for electrochemically oxidizing organic compounds as schematically shown in FIG. 9B. Referring to FIG. 9B, the invention provides a method for electrochemically oxidizing organic compounds, similar to as described above for FIG. 9A except that the second cell is not a divided cell.

In a further embodiment, the invention provides a method for electrochemically oxidizing organic compounds as schematically shown in FIGS. 9A and 9B except that neither the first nor the second cell is a divided cell.

Additional representative systems for carrying out the methods of the invention are schematically illustrated in FIGS. 10A-10C.

FIG. 10A is a schematic illustration of a representative electrochemical urine treatment devices: simplest possible device with a single anode and cathode in a planar arrangement with an applied DC voltage. In this embodiment, the urine can be gravity fed into the gap and exited at the bottom at a fixed rate requiring no moving parts.

In certain embodiments, the invention provides devices having one planar anode and one planar cathode as shown schematically in FIGS. 10A and 10B (first embodiment).

Referring to FIGS. 10A and 10B (first embodiment), the invention provides a method for electrochemically oxidizing organic compounds, comprising:

(a) contacting (e.g., flowing) an aqueous solution comprising organic compounds with a planar anode and electrochemically oxidizing at least a portion of the organic compounds to provide an aqueous solution comprising oxidation products; and

(b) contacting (e.g., flowing) the aqueous solution comprising oxidation products with a planar cathode and electrochemically reducing at least a portion of the oxidation products to provide an aqueous solution comprising reduced products and residual oxidizable organic compounds,

wherein the planar anode is positioned on a first surface, the planar cathode is positioned on a second surface, and the first surface is parallel to and separated from the second surfaces to define a channel between the planar anode and planar cathode, wherein the channel provides liquid communication of the aqueous solution comprising oxidation products with the planar cathode and liquid communication of the aqueous solution comprising reduced products and residual oxidizable organic compounds with the planar anode.

FIG. 10B (first, second, and third embodiments) are cross-sectional views of representative electrode configurations that are advantageously incorporated into systems and devices for carrying out the methods of the invention. The number of anode/cathode segments, the length of each segment, and even the composition of each anode and cathode can be varied as a function of position to maximize pharmaceutical degradation and minimize TBP formation. The alternation of anode and cathode on a single plate sequentially exposes the part of the solution that was just oxidized to a region to be reduced, without needing to stir the solution, ameliorating mass transport issues.

In certain embodiments, the invention provides devices having two planar anodes and two planar cathodes in an alternating configuration as shown schematically in FIG. 10B (second embodiment).

Referring to FIG. 10B (second embodiment), the invention provides a method for electrochemically oxidizing organic compounds, comprising:

(a) contacting (e.g., flowing) an aqueous solution comprising organic compounds with a first planar anode and electrochemically oxidizing at least a portion of the organic compounds to provide a first aqueous solution comprising oxidation products;

(b) contacting (e.g., flowing) the first aqueous solution comprising oxidation products with a first planar cathode and electrochemically reducing at least a portion of the oxidation products to provide a first aqueous solution comprising reduced products and residual oxidizable organic compounds;

(c) contacting (e.g., flowing) the first aqueous solution comprising reduced products and residual oxidizable organic compounds with a second planar anode and electrochemically oxidizing at least a portion of the organic compounds to provide a second aqueous solution comprising oxidation products; and

(d) contacting (e.g., flowing) the second aqueous solution comprising oxidation products with a second planar cathode and electrochemically reducing at least a portion of the oxidation products to provide a second aqueous solution comprising reduced products and residual oxidizable organic compounds,

wherein the first planar anode and second planar cathode are positioned on a first surface, the first planar cathode and second planar anode are positioned on a second surface, and the first surface is parallel to and separated from the second surface to define a channel between the first planar anode and the second planar cathode on the first surface and the first planar cathode and second planar anode on the second surface, wherein the channel provides liquid communication between the anodes and cathodes.

In certain embodiments, the invention provides devices having a single surface with interdigitated electrodes and or two opposing surfaces with interdigitated electrodes. Representative devices having interdigitated anodes and cathodes in an alternating configuration shown schematically in FIG. 10B (third embodiment) and 10C, respectively.

Referring to FIG. 10B (third embodiment), the invention provides a method for electrochemically oxidizing organic compounds, comprising:

(a) introducing an aqueous solution comprising organic compounds into an electrochemical cell, wherein the cell comprises:

(i) one or more anodes for electrochemically oxidizing at least a portion of the organic compounds to provide oxidation products; and

(ii) one or more cathodes for electrochemically reducing at least a portion of the oxidation products, wherein the one or more anodes and one or more cathodes are alternately positioned on a surface to provide an array of interdigitated anodes and cathodes; and

(b) conducting the aqueous solution through the cell to provide an aqueous solution comprising reduced products and residual oxidizable organic compounds.

FIG. 10C is a plan-view of one side of a plate with multiple interdigitated anodes and cathodes yielding easy electrical connection.

Referring to FIG. 10C, the invention provides a method for electrochemically oxidizing organic compounds, comprising:

(a) introducing an aqueous solution comprising organic compounds into an electrochemical cell, wherein the cell comprises:

(i) a first surface comprising

one or more anodes for electrochemically oxidizing at least a portion of the organic compounds to provide oxidation products, and

one or more cathodes for electrochemically reducing at least a portion of the oxidation products,

wherein the one or more anodes and one or more cathodes are alternately positioned on the surface to provide an array of interdigitated anodes and cathodes; and

(ii) a second surface comprising

one or more cathodes for electrochemically reducing at least a portion of the oxidation products, and

one or more anodes for electrochemically oxidizing at least a portion of the organic compounds to provide oxidation products;

wherein the one or more anodes on the first surface and the one or more cathodes on the second surface are alternately positioned on each surface to provide an array of interdigitated anodes and cathodes,

wherein the first surface is parallel to and separated from the second surface to define a channel between the interdigitated anodes and cathodes on the first surface and the interdigitated anodes and cathodes on the second surface, wherein the channel provides liquid communication between the anodes and cathodes; and

(b) conducting the aqueous solution through the cell to provide an aqueous solution comprising reduced products and residual oxidizable organic compounds.

In the methods described herein, the anode generates oxidants. Representative oxidants generated by the anode include surface bound hydroxyl radicals, dissolved hydroxyl radicals, chlorine radicals, HOCl and OCl⁻, and carbonate radicals. In certain embodiments, the anode is a metal oxide or a combination of metal oxides (e.g., doped metal oxides, doped tin oxide, fluorine-doped tin oxide). In certain embodiments, the anode or the surface of the anode comprises carbon (e.g., amorphous carbon, graphite, graphene, graphene oxide, diamond, doped carbon, boron-doped diamond). In certain embodiments, the anode is a boron-doped diamond anode. In other embodiments, the anode is an iridium dioxide (IrO₂) anode.

In the methods described herein, the cathode is effective in reducing chlorate, perchlorate, haloacetic acids, halomethanes, haloethanes, and nitrosamines. In certain embodiments, the cathode is a metal or a combination of metals. Representative metals include iron, platinum, molybdenum, titanium, nickel, silver, and copper. Representative combinations of metals include steel and stainless steel. In certain embodiments, the cathode is a carbon cathode. Representative carbon cathodes comprise amorphous carbon, graphite, graphene, graphene oxide, diamond, doped carbon, and boron-doped diamond.

In the methods described herein, the organic compounds that are effectively treated are organic compounds that are capable being degraded by electrochemical oxidization. Representative organic compounds capable being degraded by electrochemical oxidization include pharmaceutical compounds. Representative degradable pharmaceutical compounds include fluoxetine, sertraline, metformin, carbamazepine, ibuprofen, sulfamethoxazole, and cyclophosphamide. In certain embodiments, the organic compounds are polychlorinated biphenyls.

In certain embodiments, the aqueous solution subject to electrochemical oxidation further comprises a microorganism, which is effectively degraded by the methods described herein. Representative microorganisms include Cholera (Vibrio cholerae), Cladoceran Water Flea (Cercopagis pengoi), Mitten Crab (Eriocheir sinensis), toxic algae, Round Goby (Neogobius melanostomus), North American Comb Jelly (Mnemiopsis leidyi), North Pacific Seastar (Asterias amurensis), Zebra Mussel (Dreissena polymorpha), Asian Kelp (Undaria pinnatifida), and European Green Crab (Carcinus maenas).

In certain embodiments, the aqueous solution comprising organic compounds is ship ballast water.

In other embodiments, the methods described herein are useful as point-source treatment pre-dilution in wastewater treatment facilities. In certain of these embodiments, the aqueous solution comprising organic compounds is human urine and the organic compounds to be electrochemically oxidatively degraded are pharmaceuticals.

Electrochemical Systems

Representative systems (i.e., electrode configurations) for carrying out the methods of the invention are schematically illustrated in FIGS. 9A, 9B, and 10A-10C. Suitable power sources controllably apply voltage (e.g., DC) to the electrodes of these systems.

FIG. 9A illustrates a two-cell system (100) that includes first divided cell 200 and second divided cell 300 in liquid communication with first divided cell 200. First divided cell 200 includes anode compartment 210 having anode 212 and cathode compartment 220 having cathode 222 separated by permeable membrane 215. Aqueous solution to be oxidized is introduced into compartments 210 and 220 by conduits 214 and 224, respectively. Second divided cell 300 includes cathode compartment 310 having cathode 312 and anode compartment 320 having anode 322 separated by permeable membrane 315. Conduit 216 directs aqueous solution from anode compartment 210 to cathode compartment 310. Conduit 226 directs aqueous solution from cathode compartment 220 to anode compartment 320. Hydrogen gas generated in cathode compartment 220 is optionally directed to cathode compartment 310 by conduit 228. Aqueous solution from cathode compartment 310 and anode compartment 320 are exited from the compartments by conduits 316 and 326, respectively, and optionally combined and are either recycled to first divided cell 200 or exited to a WWTF by conduit 328.

FIG. 9B illustrates a second two-cell system (400) that includes first divided cell 500 and second cell 600 in liquid communication with first divided cell 500. First divided cell 500 includes anode compartment 510 having anode 512 and cathode compartment 520 having cathode 522 separated by permeable membrane 515. Aqueous solution to be oxidized is introduced into compartments 510 and 520 by conduits 514 and 524, respectively. Second cell 600 includes cathode 612 and anode 622. Conduit 516 directs aqueous solution from anode compartment 510 to cell 600. Conduit 526 directs aqueous solution from cathode compartment 520 to cell 600. Hydrogen gas generated in cathode compartment 520 is optionally directed to cell 600 by conduit 528. Aqueous solution from cell 600 is exited from the cell by conduit 628, and optionally combined and are either recycled to first divided cell 500 or exited to a WWTF by conduit 628.

In certain embodiments, the systems of the invention include planar arrangements of electrodes (anodes and cathodes). FIGS. 10A-10C are schematic illustrations of representative systems of the invention (e.g., electrochemical urine treatment devices).

FIG. 10A and FIG. 10B (first embodiment) illustrate the simplest possible system with a single anode and cathode in a planar arrangement with an applied DC voltage. In this embodiment, the urine can be gravity fed into the gap and exited at the bottom at a fixed rate requiring no moving parts. Referring to FIG. 10A, system 600 includes planar anode 610 is positioned on first surface 620 and planar cathode 630 positioned on second surface 640, wherein first surface 620 is essentially parallel to and separated from second surface 640 to define a channel between planar anode 610 and planar cathode 630, wherein the channel provides liquid communication of the aqueous solution comprising oxidation products between the electrodes.

FIG. 10B illustrates cross-sectional views of representative systems illustrating representative electrode sequencing schemes. The number of anode/cathode segments, the length of each segment, and even the composition of each anode and cathode can be varied as a function of position to maximize pharmaceutical degradation and minimize TBP formation. The alternation of anode and cathode on a single plate sequentially exposes the part of the solution that was just oxidized to a region to be reduced, without needing to stir the solution, ameliorating mass transport issues.

In certain embodiments, the invention provides devices having two planar anodes and two planar cathodes in an alternating configuration as shown schematically in FIG. 10B (second embodiment).

Referring to FIG. 10B (second embodiment), system 700 includes first planar anode 710 and second planar cathode 720 positioned on first surface 730, and first planar cathode 740 and second planar anode 750 positioned on second surface 760, where first surface 730 is essentially parallel to and separated from second surface 760 to define a channel between first planar anode 710 and second planar cathode 720 on first surface 730 and first planar cathode 740 and second planar anode 750 on the second surface 760, where the channel provides liquid communication between the electrode surfaces.

In certain embodiments, the invention provides systems having a single surface with interdigitated electrodes and or two opposing surfaces with interdigitated electrodes. Representative devices having interdigitated anodes and cathodes in an alternating configuration shown schematically in FIG. 10B (third embodiment) and 10C, respectively.

Referring to FIG. 10B (third embodiment), system 800 includes multiple anodes 810 and multiple cathodes 820 alternatively positioned on first surface 830 to provide a first array of interdigitated anodes and cathodes, and multiple anodes 910 and multiple cathodes 920 alternately positioned on second surface 930 to provide a second array of interdigitated anodes and cathodes. First surface 830 is essentially parallel to and separated from second surface 930 to define a channel between first and second electrode arrays, where the channel provides liquid communication between the electrode surfaces. FIG. 10C is a plan-view of one side of a plate with multiple anode and cathode sections interdigitated, yielding easy electrical connection. Referring to FIG. 10C, system 800 includes multiple anodes 810 and multiple cathodes 820 alternately positioned on surface 830 to provide an array of interdigitated anodes and cathodes.

The following is a description of representative systems and methods of the invention.

The Advantages of Decentralized Treatment of Urine

Point-source treatment of fresh urine has multiple advantages: (1) chemical oxygen demand (COD), (2) conductivity, (3) nitrogen content. Average human urine production is 1.3 Lp⁻¹d⁻¹, while average domestic wastewater discharge is 148 Lp⁻¹d⁻¹. The dilution of urine with these other waste streams not only decreases the absolute concentration of pharmaceuticals, but it also decreases their relative concentration compared to the total concentration of organics in the solution. This is due to mixing with other organics such as cooking oils, and detergents. This domestic wastewater may be further diluted by other waste streams containing other organics before reaching a WWTF (e.g., industrial wastewater, urban runoff). One way to quantify this is to compare the COD from pharmaceuticals vs. the COD of the matrix on a per person per day as shown in Table 1.

TABLE 1
Estimates for the required charge and cost to electrochemically oxidize
pharmaceuticals in domestic wastewater streams per person per day

| | | | | | Required | Daily |
|---|---|---|---|---|---|---|
| | Volume | Matrix COD | Pharm COD | Pharm COD/ | Charge Passed | Electricity |
| Matrix | [Lp⁻¹d⁻¹] | [mg/L] | [mg/L] | Matrix COD | [A · hrs] | Cost |
| Pure | 1.3 | 0 | 1,600.00 | 100% | 5.81 | $0.0697 |
| Pharmaceuticals | | | | | | |
| Pharmaceuticals | 1.3 | 10000 | 1,600.00 | 14% | 42.10 | $0.5052 |
| in Urine | | | | | | |
| Domestic | 148 | 702.7 | 14.05 | 2.0% | 296.16 | $3.5539 |
| Wastewater | | | | | | |

In Table 1, the calculations assumed an electricity rate of 0.15 $/kWhr, a pharmaceutical concentration of 10 mM (which is estimated to require 100 mM of oxygen for COD calculations), an applied voltage of 6 V, a faradaic efficiency toward reactive oxidant generation of 15%, and assumes 50% of oxidants react to reduce COD. Matrix composition taken from Larsen, Source Separation and Decentralization for Wastewater Management. Water Intell. Online 12, (2013).

In a scenario where pharmaceuticals are the only source of COD in the matrix, it would take only 50.07 to oxidize all pharmaceuticals. This cost is moderately increased to $0.50 when all the COD of the urine matrix is included and is substantially increased to $3.55 when COD from all domestic wastewater is included. The CODₚₕₐᵣₘ/CODₜₒₜₐₗ decreases from 14% to 2% once the urine stream is mixed with other domestic wastewater streams. The calculations presented in Table 1 represent a lower bound on the daily cost for electrochemical treatment of these systems, particularly for the larger treatment volumes. Diluted fresh urine has substantially larger volume and lower conductivity, which drastically increases the cost required to electrochemically remediate pharmaceuticals due to larger electrode requirements, longer treatment times, and high solution resistivity.

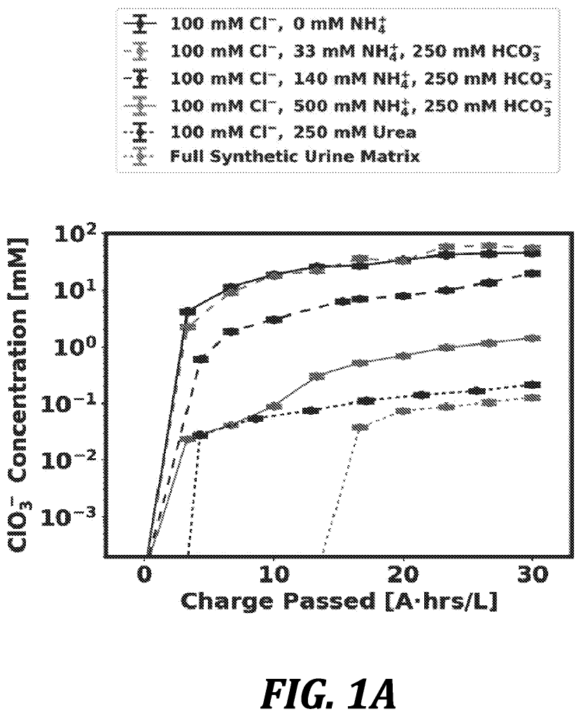

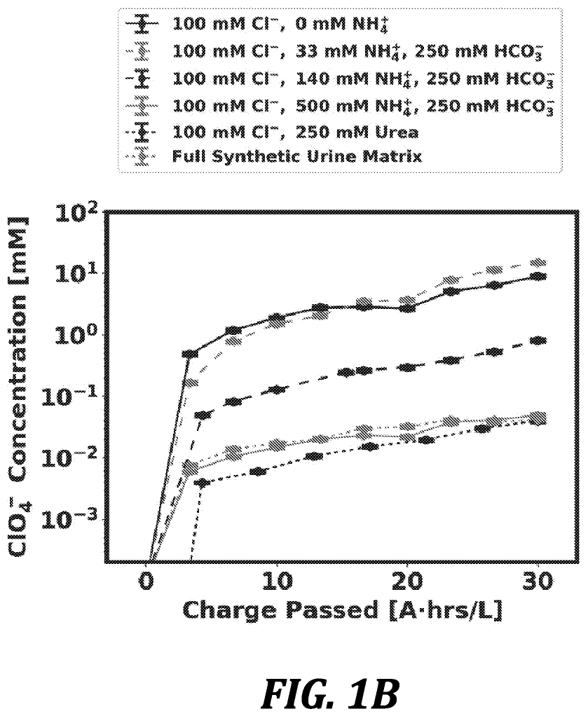

Another major benefit of treating pharmaceutical containing urine at its source is the high urea content in urine, which inhibits the formation of chlorate and perchlorate. To examine how dissolved nitrogen concentration affects the formation of perchlorate, a series of oxidations were performed on a BDD electrode as shown in FIG. 1. Fresh urine has an average concentration of 250 mM urea and 100 mM Cl⁻, which corresponds to 500 mM NH₄⁺ after urea hydrolysis. Studies which examined treatment of stored urine have measured substantially less NH₄⁺ with values of 34 mM and 109 mM, which suggest there was substantial ammonia evaporation in these studies. As shown in FIG. 1, the ClO₃⁻ and ClO₄⁻ generated during oxidation is inhibited by more than three orders of magnitude when for a matrix of 100 mM Cl⁻ and 250 mM urea compared to 100 mM Cl⁻ alone. A matrix containing corresponding concentrations of hydrolyzed urine (100 mM Cl⁻, 500 mM NH₄⁺, and 250 mM HCO₃⁻) also shows the same suppression in ClO₄ generation, but the generated ClO₃⁻ is one order of magnitude higher. For decreasing concentrations of NH₄⁺ in the matrix, substantially more ClO₃⁻ and ClO₄⁻ is generated during oxidation. One explanation of this behavior is that ammonia species scavenge active chloride species, which inhibits their further oxidation. Urea has been measured to react with active chlorine species at a rate of 0.63 M⁻¹s⁻¹, and at high concentrations, this is suspected to be faster than the oxidation pathways which lead to ClO₃⁻ and ClO₄⁻.

The Oxidation of Pharmaceutical in a Simple Urine Matrix

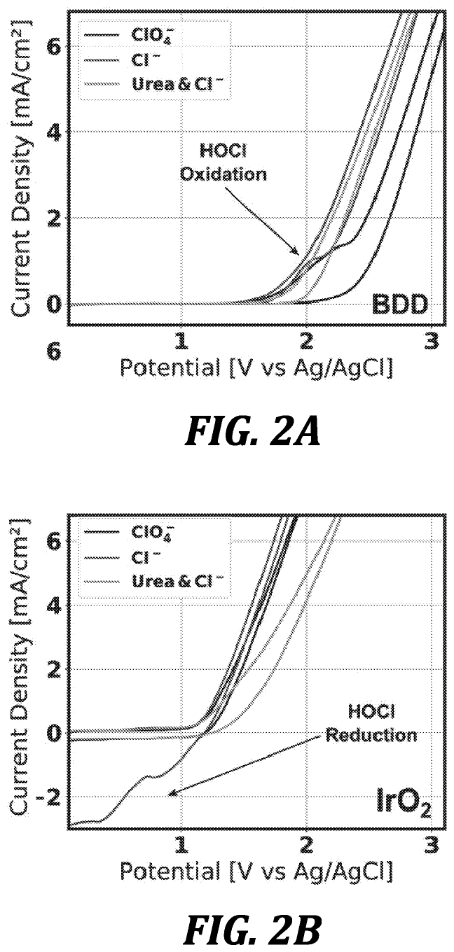

FIG. 2 shows CVs of oxidative sweeps of three different solutions on boron-doped diamond (BDD) and thermally decomposed iridium oxidize (IrO₂). The CVs of BDD in FIG. 2A show a difference of 200 mV in the onset of current between the ClO₄⁻ and other solutions. This is due to the lower overpotential required for chlorine evolution vs. oxygen evolution on BDD. In the Cl⁻ solution, there is a rapid increase in the current in the anodic sweep near 1.9 V, which corresponds to the oxidation of active chlorine species. This is absent in the Cl⁻ and urea solutions, suggesting that the active chlorine species have been scavenged by the urea. This is commensurate with the suppression of ClO₃⁻ and ClO₄ generation shown in FIG. 1.

In contrast to BDD, the CVs of IrO₂ in FIG. 2B show little difference in the onset of current evolution and magnitude of current when Cl⁻ is present. The surface of IrO₂ anodes are known to oxidize according to IrO₂+H₂O⇄Ir(OH)₃+H⁺+e⁻. Therefore, the oxidation pathways involving these surface oxides toward Cl₂ and O₂ must have similar kinetics. In the Cl⁻ only solutions on IrO₂, the peak seen in the cathodic sweep from 1.2 to 0 V likely corresponds to the reduction of oxidized chlorine species, such as HOCl or surface-bound Cl′. The absence of this peak when urea is present in the matrix again demonstrated that urea scavenges HOCl and/or surface-bound Cl⁻.

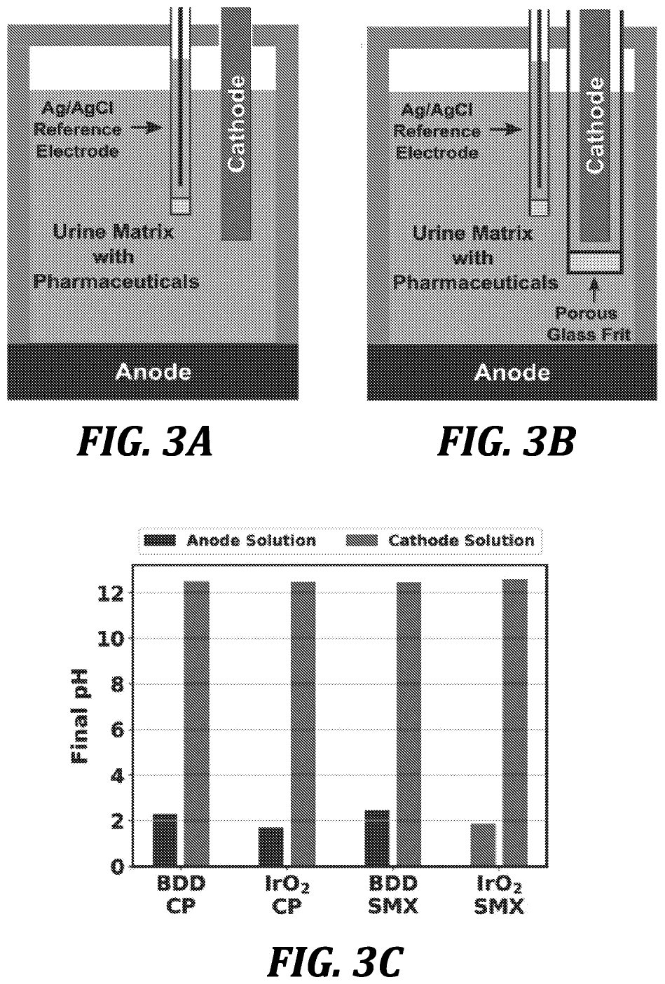

In order to examine the potential of point-source treatment of pharmaceuticals in fresh-urine matrices, a series of experiments were performed with BDD and IrO₂ anodes. Oxidation experiments were performed on both of these electrodes with one of two pharmaceuticals, sulfamethoxazole (SMX) and cyclophosphamide (CP), each in a non-divided and divided cell configuration. CP and SMX were chosen as test compounds because of their major differences in reactivity toward active chlorine species. SMX has a relatively high bimolecular rate constant with HOCl of 10³ M⁻¹s⁻¹, while we measured CP to have an exceptionally low bimolecular rate constant of about 10⁻⁶ M⁻¹s⁻¹. A schematic of the non-divided and divided cell configurations for oxidation are shown in FIG. 3A and FIG. 3B, respectively. For the divided cell setup, a glass frit (with porosity 4-8 um) proved to be a simple, cheap way to prevent mixing of solutions in the anode and cathode compartments. Furthermore, this led to large pH difference between the two compartments as shown in FIG. 3C. The pH gradient is established because the oxygen evolution reaction at the anode generates H+ while the hydrogen evolution reaction at the cathode generates OH−. Positive ions flow from anode to cathode, and negative ions flow from cathode to anode through the glass frit, which counteracts this gradient. However, given that Na+ and Cl− are both at 0.1 M, H+ and OH− are expected to accumulate in the anode and cathode chambers until their concentration is on the order of Na+ and Cl−. On average, the pH in the anode chamber stabilized to 1.8 and 2.3 for IrO₂ and BDD, respectively. Furthermore, this gradient is quickly established. Passing 10 mA/cm² for 5 mins (about 0.2 A·hrs/L) was sufficient to establish a gradient of about 10 pH units for both BDD and IrO₂. This simple, inexpensive technique to adjust the pH of the matrix has many potential advantages. First, acidification of urine to pH 2 has been shown to prevent hydrolysis of urea for over 200 days. This could prove useful to prevent urea hydrolysis and ammonia loss for device designs where large volumes of concentrated urine are collected before treatment. Second, many pharmaceuticals have different susceptibility to oxidation depending on the solution pH, typically due to the protonation/deprotonation of amine groups. Controlled mixing of the basic cathode compartment solution with the anode compartment solution could be used to set the pH to a value that maximizes degradation of a particularly recalcitrant pharmaceutical. Third, low pH environments are generally more favorable toward reduction. Therefore, the efficacy of subsequent reduction treatments on the anode compartment solution to degrade TBPs is drastically enhanced.

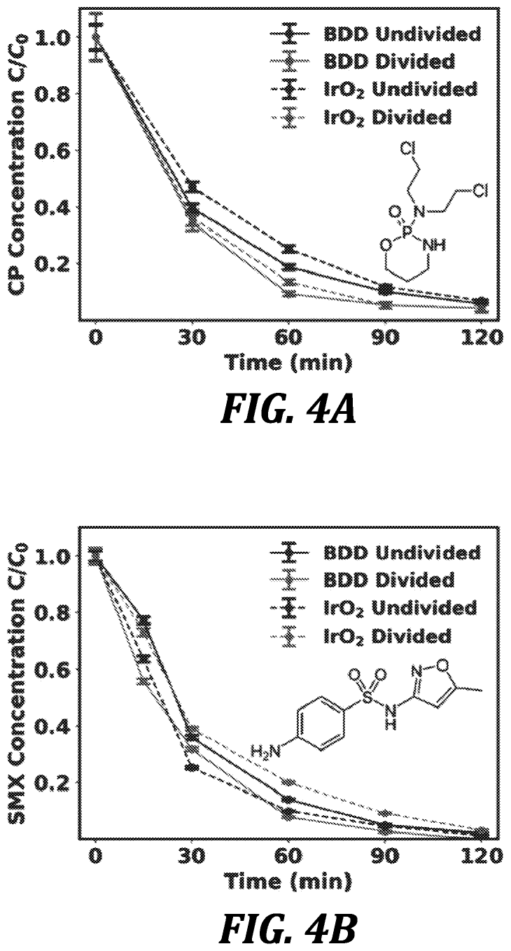

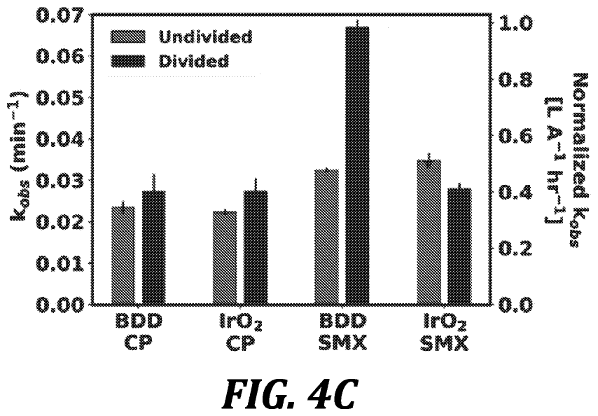

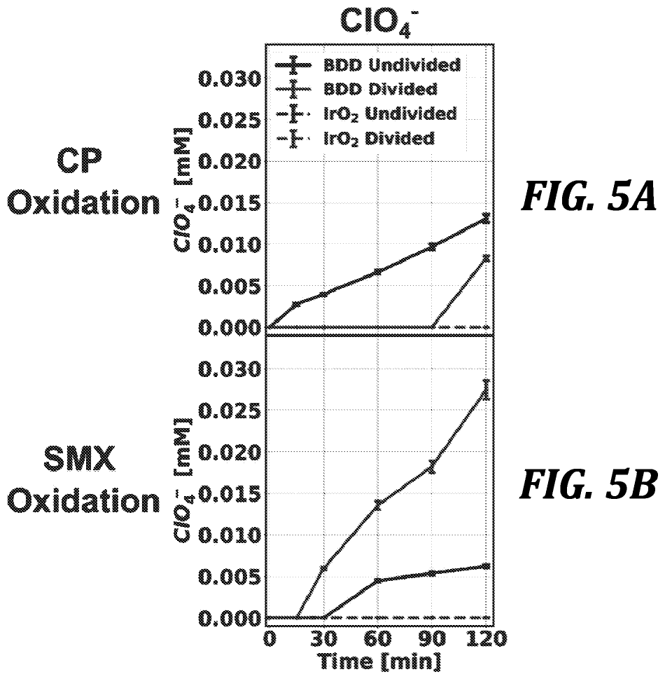

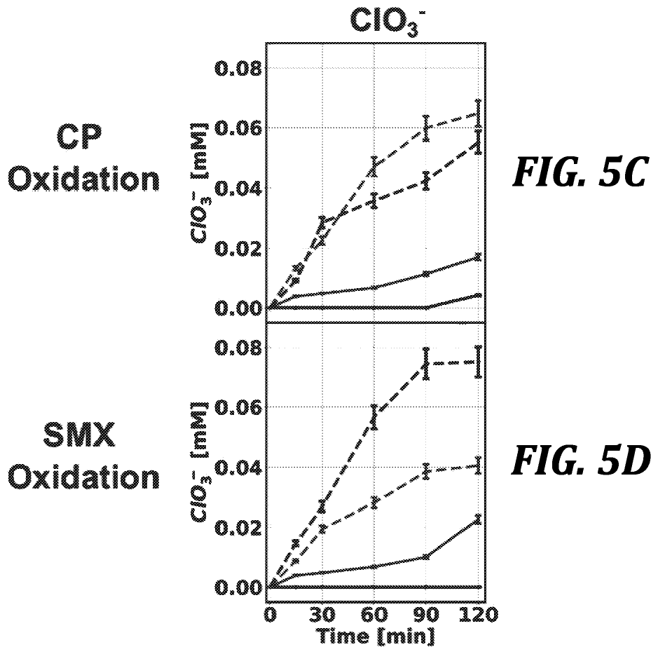

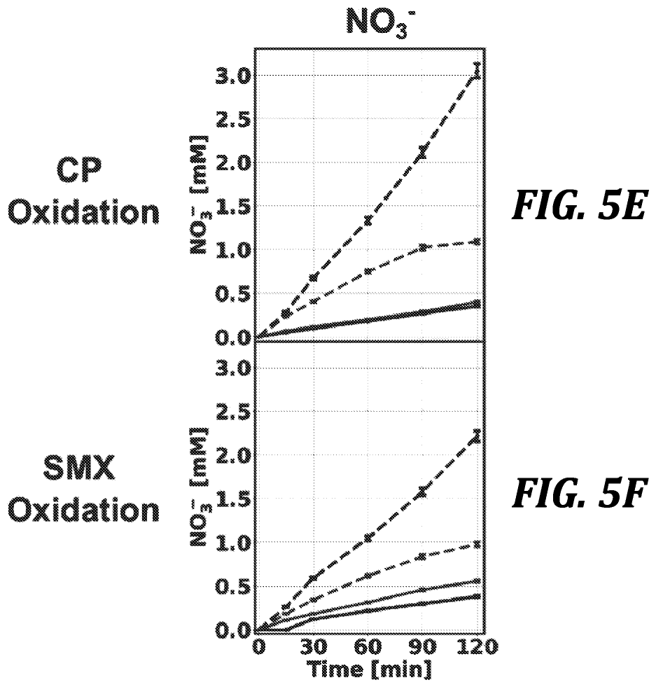

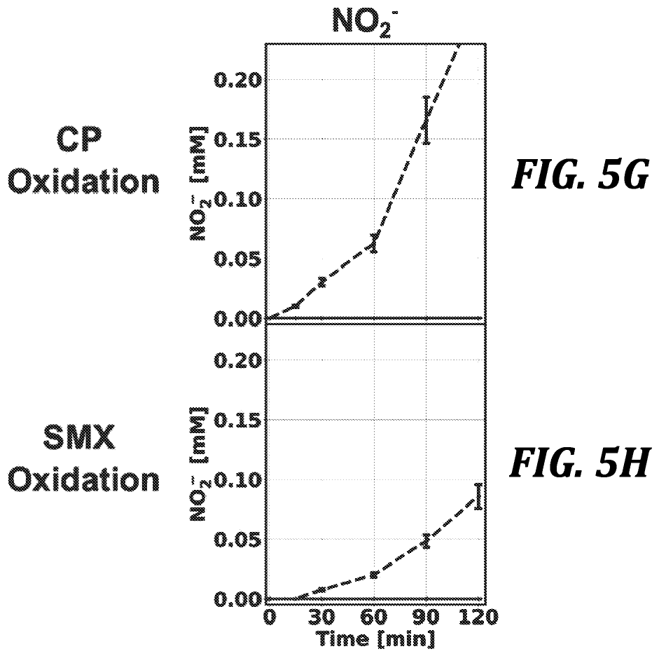

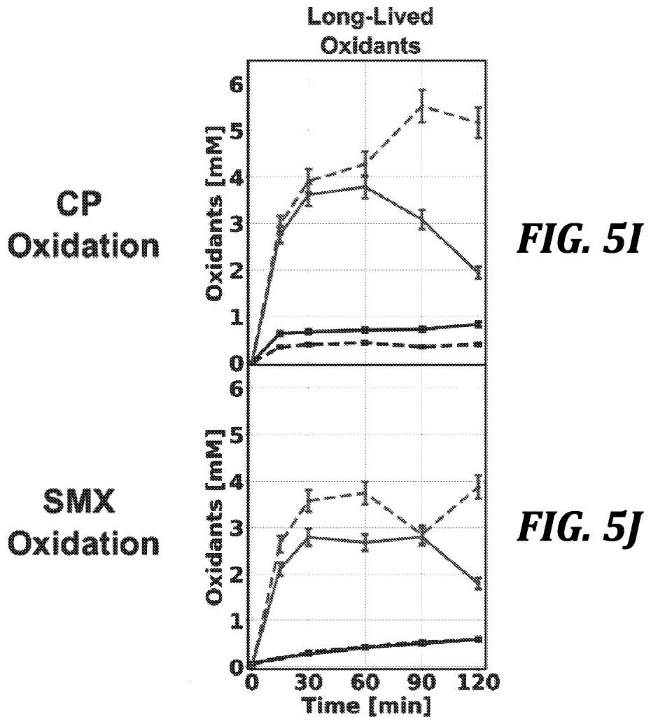

The rate of pharmaceutical degradation and the rate of toxic byproduct generation were compared between every combination of pharmaceutical, anode, and cell configuration as shown in FIG. 4 and FIG. 5, respectively. FIG. 4 shows that CP and SMX can be degraded to below 90% of their starting value after two hours of oxidation at 10 mA/cm² (4.28 A hrs/L) for both cell setups on each electrode. The observed pseudo-first-order rate constant for degradation was similar for both electrodes, with the exception of SMX on BDD which had an exceptionally higher degradation rate constant. This higher rate constant could be partially due to the higher dissolved oxidant concentration (FIG. 5J), but a such a drastic improvement was not seen on IrO₂ despite a similar increase in dissolved oxidants. The large increase in the SMX degradation in the BDD divided cell can be due to higher concentrations of Cl. A pH-dependent equilibrium of ClOH.− with Cl. and HO. has been shown to favor Cl. at low pH and HO. at high pH. Given the exceptionally high rate of reactivity of SMX toward chlorinated byproducts via active chlorine species, it is believed that Cl reacts faster with SMX than the OH. Both perchlorate (FIGS. 5A and 5B) and chlorate (FIGS. 5C and 5D) were near or below the detection limit for the ion chromatography techniques used in these experiments. No perchlorate was measured in matrices oxidized by the IrO₂ anode, which is similar to reported previously. Perchlorate was formed in the matrices oxidized on the BDD anode, but much lower concentrations than what has been reported previously. This is due to the urea in solution as discussed above. Nitrate (FIGS. 5E and 5F) and nitrite (FIGS. 5G and 5H) generation was found to be higher on the IrO₂ electrode than the BDD electrode. These nitrogen compounds could come from the oxidation of urea and/or the oxidation of CP/SMX. However, in the IrO₂ divided cell experiments, nitrate generation was substantially reduced and nitrite was below the detection limit. A reaction pathway with nitrite and OH has been shown to lead to nitrosamines, which are acute TBPs. Therefore, the suppression of both the NO₂ and the NO₃ in using the IrO₂ divided cell configuration is an indication that these pathways are not active. Quantification of the dissolved oxidants (FIGS. 5I and 5J), showed that they were 2-10× more concentrated in the divided cell setup. This is likely related to the fact that in an undivided setup, dissolved oxidants such as H₂O₂ and HOCl are expected to be reduced at the cathode.

The Reduction of TBPs in an Acidified Urine Matrix

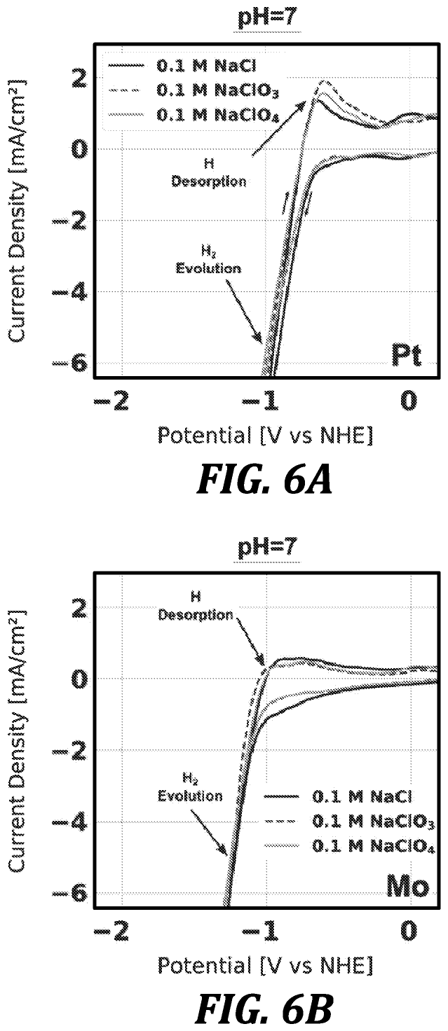

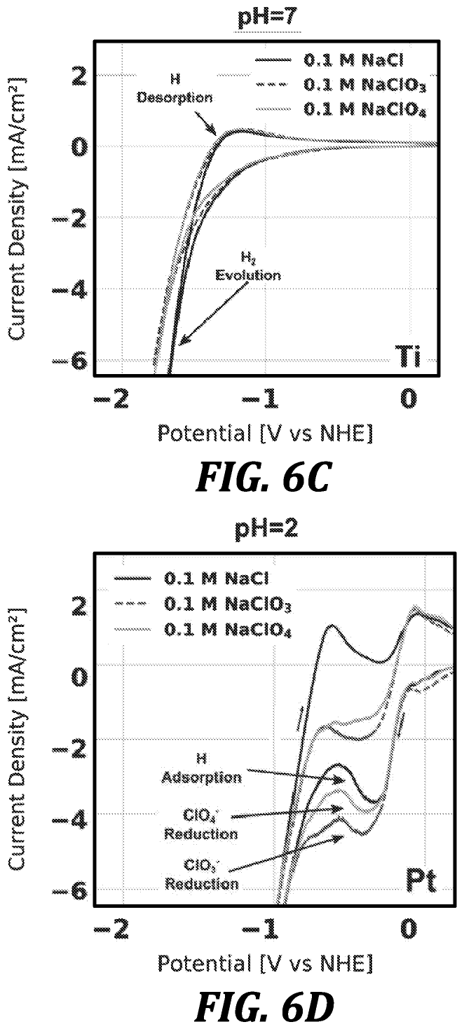

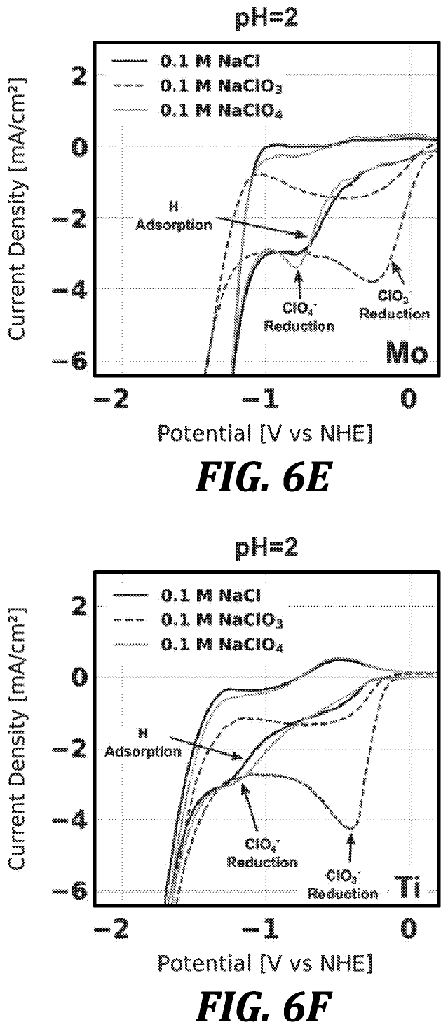

In order to demonstrate the potential of a reduction treatment after an advanced oxidation process, a series of reduction experiments were performed on platinum (Pt), molybdenum (Mo), and titanium (Ti) cathodes. FIG. 6 compares the CVs of these cathodes for four matrices: NaCl at pH 7, NaCl at pH 2, NaClO₃ at pH 2, and NaClO₄ at pH 2. CVs of NaClO₃ and NaClO₄ solutions at pH 7 look identical to the Cl⁻ pH 7 solution. The peaks corresponding to chlorate and perchlorate reduction are only present at pH 2. A prominent cathodic peak for the NaCl at pH 2 matrix is seen at −0.7 V, −1.0 V, and −1.5 V for Pt, Mo, and Ti, respectively. A similar peak has been previously attributed to adsorption of hydrogen at the cathode for Pt, and this peak is all but absent for the CVs of the NaCl/pH 7 matrix. This peak is therefore attributed to the adsorption of hydrogen for all of these cathodes. For the ClO₄ containing matrix, the hydrogen adsorption peak is decreased for the Mo and Ti electrodes. This may be indicative of surface bound ClO₄ reducing the surface area for hydrogen adsorption. For all electrodes, the desorption of hydrogen can be seen during the anodic sweep, with the highest magnitude for the NaCl/pH 7 matrix. This is due to the low concentration of H+ in solution, which provides a relatively strong driving force for the desorption of surface bound hydrogen. ClO₃⁻ is readily reduced by all electrodes, as indicated by the prominent cathodic peak at −0.4, −0.4, and −0.7 V for Pt, Mo, and Ti, respectively. Note the absence of a hydrogen adsorption peak for the pH 2 chlorate solution. The hydrogen ion concentration is an order of magnitude less than that of chlorate, and because it is directly involved in the reduction of chlorate, the cathode the hydrogen adsorption peak is absent. From FIG. 6, Pt is seen as the most favorable towards the hydrogen evolution reaction (HER), Mo has a slightly later onset potential, and Ti has the largest inert window.

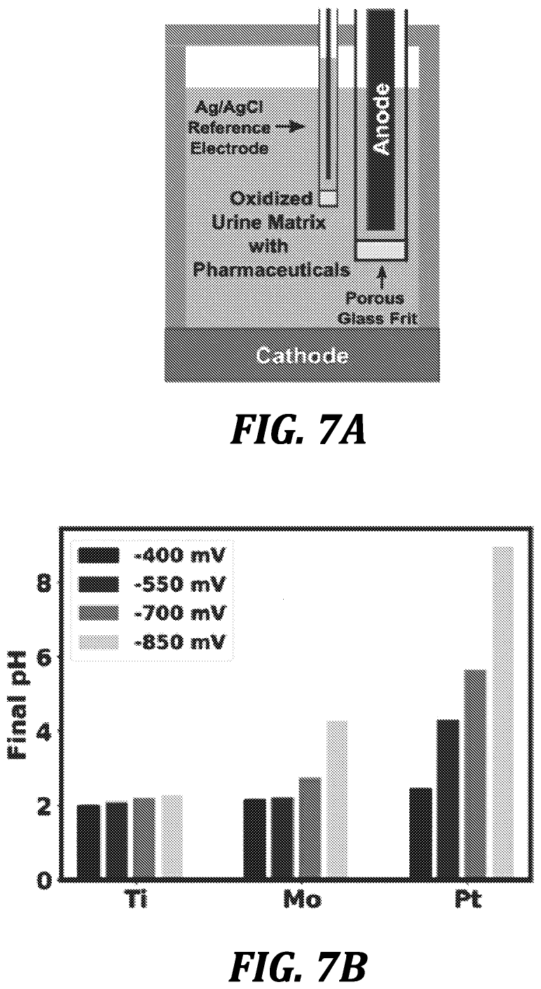

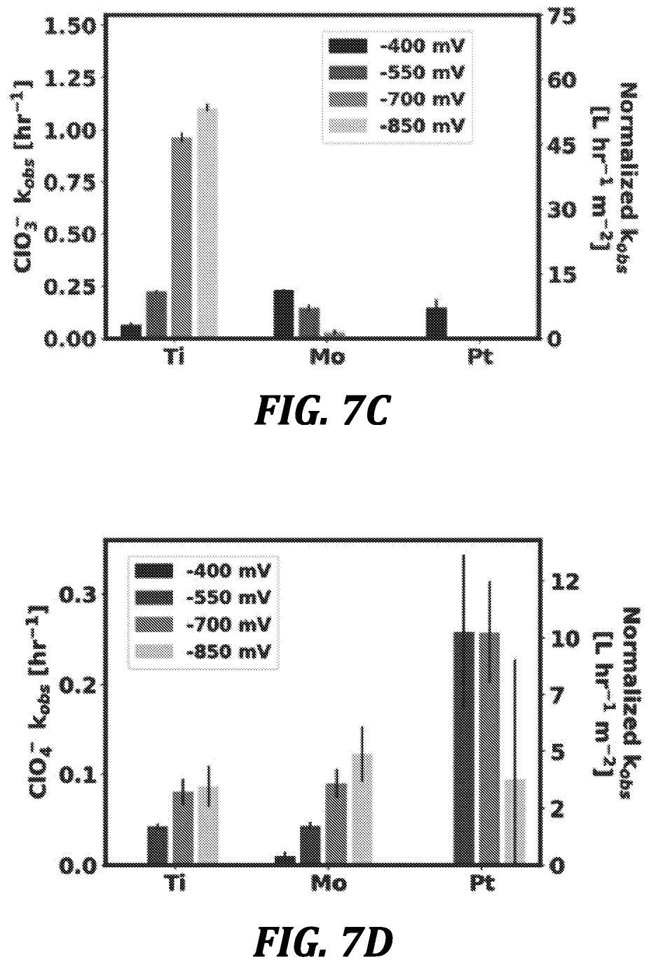

In order to test the optimum reduction conditions for the oxidized urine matrix, a pH 2 solution with 5 ppm of ClO₄ and 30 ppm of ClO₃⁻ was reduced on Pt, Mo, and Ti cathodes. In all of these experiments, a potentiostatic voltage was maintained (at −400, −550, −700, or −850 mV) for 3 hours in a divided cell (as depicted in FIG. 7A), and the concentration of ClO₃⁻ and ClO₄⁻ were measured over time. A key feature of this experiment is the competition between the HER and the reduction of the oxychlorides, both of which consume surfaced adsorbed hydrogen. The final pH of the solutions was drastically increased for the Pt cathode, moderately increased for the Mo cathode, and slightly increased for the Ti cathode (FIG. 7B). An increasing kinetic barrier for the HER in order of Ti>Mo>Pt explains this pH difference, which is further supported by the difference in the inert potential window in FIG. 6. The change in the ClO₃⁻ and ClO₄⁻ concentration over time was used to extract first order rate constants, which can be found in FIGS. 7C and 7D. Ti proved to have exceptionally fast kinetics toward the reduction of ClO₃⁻, with almost complete removal from the matrix in 3 hours when held at potentiostatic voltage of −850 mV. The rate constant for ClO₃⁻ reduction increased monotonically on Ti for the potentials studied, which is likely related to the increasing driving force toward ClO₃⁻ reduction while not generating much hydrogen (as indicated by the constant pH). By contrast, the rate constant for ClO₃⁻ reduction decreased monotonically on Mo, while the pH of the final solution increased. This indicates a higher faradaic efficiency toward the HER and a lower faradaic efficiency toward ClO₃⁻ reduction as potential is increased. This is even more drastic in the case of Pt, where no measurable ClO₃⁻ reduction was measured. A moderate amount of ClO₄ was reduced in the timescale of this experiment on all electrodes.

Alternation of Oxidation and Reduction

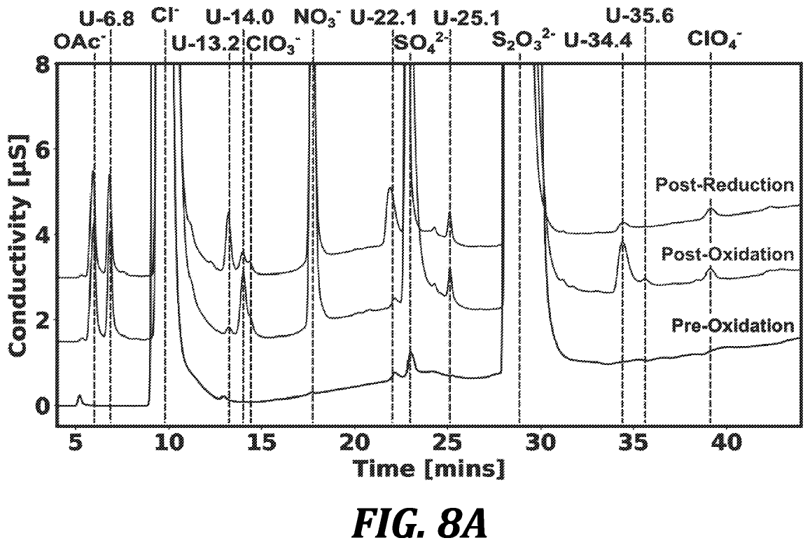

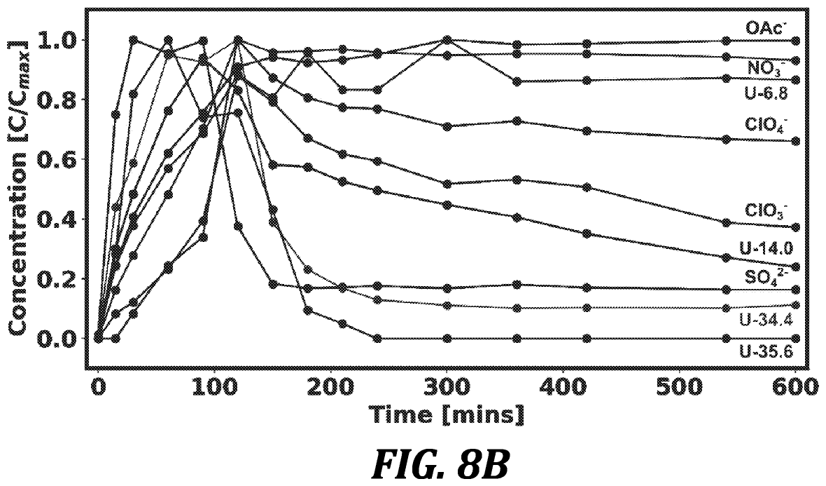

In order to demonstrate the potential of a subsequent reduction treatments in AOPs to remediate TBPs, we performed a reduction treatment on acidified, oxidized urine matrices as shown in FIG. 8. The original matrix contained 100 mM NaCl, 250 mM urea, and 500 ppm and showed little evidence of other constituents (apart from S₂O₃²⁻) as shown in FIG. 8A.

As also shown in FIG. 8A, after oxidation on BDD at 10 mA/cm², a number of oxidation byproducts form, including ClO₃⁻ and ClO₄⁻. A number of IC peaks corresponding to oxidation byproducts are highlighted with guidelines in FIG. 8A, and their peak areas (normalized to the maximum peak area) are tracked over the course of the oxidation experiment in the red shaded region of FIG. 8B. A subsequent reduction treatment was performed using a Ti electrode maintained at −850 mV for 480 mins, and the same IC peaks are tracked in the blue region of FIG. 8B. As expected, based on the reduction experiment highlighted in FIG. 7, there was a decrease in the concentration in the ClO₃⁻ and ClO₄⁻, however; the rate was slower that previously measured. This may in part be due to the competitive reduction of other unknown oxidation byproducts, which are labeled U-14.0. U-34.4, and U-35.5. The final pH of the solution before reduction was 2.3, and it rose to 9.0 after the 480 mM reduction treatment. This may suggest that the reduction potential of −850 mV was high enough for the HER to slowly raise the pH over time. Nevertheless, these data are an illustration of the potential of post-oxidation reduction treatments to reduce TBPs using these divided cell schemes. Representative device designs are shown in FIGS. 9A, 9B, and 10.

While illustrative embodiments have been illustrated and described, it will be appreciated that various changes can be made therein without departing from the spirit and scope of the invention.

1. A method for electrochemically oxidizing organic compounds, comprising:
(a) contacting an aqueous solution comprising organic compounds with a first anode and electrochemically oxidizing at least a portion of the organic compounds to provide a first aqueous solution comprising oxidation products; and
(b) contacting the first aqueous solution comprising oxidation products with a first cathode and electrochemically reducing at least a portion of the oxidation products to provide a first aqueous solution comprising reduced products and residual oxidizable organic compounds.

2. The method of claim 1, further comprising contacting the first aqueous solution comprising reduced products and residual oxidizable organic compounds with a second anode and electrochemically oxidizing at least a portion of the residual oxidizable organic compounds to provide a second aqueous solution comprising oxidation products.

3. The method of claim 2, wherein the second anode is the same as or different from the first anode.

4. The method of claim 3, further comprising contacting the second aqueous solution comprising oxidation products with a second cathode and electrochemically reducing at least a portion of the oxidation products to provide a third aqueous solution comprising reduced products and residual oxidizable organic compounds.

5. The method of claim 4, wherein the second cathode is the same as or different from the first cathode.

6. The method of claim 1, comprising:
(a) electrochemically oxidizing at least a portion of organic compounds in an aqueous solution in a first divided cell having a first anode compartment separated from a first cathode compartment by a porous membrane to provide a first aqueous solution comprising oxidation products;
(b) conducting the first aqueous solution comprising oxidation products to a second divided cell having a second anode compartment separated from a second cathode compartment by a porous membrane; and
(c) electrochemically reducing at least a portion of the oxidation products in the second divided cell to provide an aqueous solution comprising reduced products.

7. The method of claim 6, wherein the aqueous solution of reduced products comprises residual oxidizable organic compounds and is conducted to the first divided cell and at least a portion of the residual oxidizable organic compounds are electrochemically oxidized to provide a second aqueous solution comprising oxidation products.

8. The method of claim 7, wherein the second aqueous solution comprising oxidation products and is conducted to the second divided cell and at least a portion of the oxidation products are electrochemically reduced to provide a second aqueous solution comprising reduced products.

9. The method of claim 6, wherein the first aqueous solution comprising oxidation products from the anode compartment of the first divided cell is conducted to the cathode compartment of the second divided cell and the first aqueous solution comprising oxidation products from the cathode compartment of the first divided cell is conducted to the anode compartment of the second divided cell.

10. The method of claim 9, wherein the first aqueous solution comprising oxidation products conducted to the cathode compartment of the second divided cell and the first aqueous solution comprising oxidation products conducted to the anode compartment of the second divided cell are reduced to provide a second aqueous solution comprising reduced products.

11. The method of claim 10, wherein the second aqueous solution comprising reduced products and residual oxidizable organic compounds are conducted from the cathode and anode compartments of the second divided cell to the first divided cell for further oxidation.

12. The method of claim 9, wherein hydrogen generated in the cathode compartment of the first cell is conducted to the second cell to enhance reduction.

13. The method of claim 1, comprising:
(a) contacting an aqueous solution comprising organic compounds with a planar anode and electrochemically oxidizing at least a portion of the organic compounds to provide an aqueous solution comprising oxidation products; and
(b) contacting the aqueous solution comprising oxidation products with a planar cathode and electrochemically reducing at least a portion of the oxidation products to provide an aqueous solution comprising reduced products and residual oxidizable organic compounds,
wherein the planar anode is positioned on a first surface, the planar cathode is positioned on a second surface, and the first surface is parallel to and separated from the second surfaces to define a channel between the planar anode and planar cathode, wherein the channel provides liquid communication of the aqueous solution comprising oxidation products with the planar cathode and liquid communication of the aqueous solution comprising reduced products and residual oxidizable organic compounds with the planar anode.

14. The method of claim 1, comprising:
(a) contacting an aqueous solution comprising organic compounds with a first planar anode and electrochemically oxidizing at least a portion of the organic compounds to provide a first aqueous solution comprising oxidation products;
(b) contacting the first aqueous solution comprising oxidation products with a first planar cathode and electrochemically reducing at least a portion of the oxidation products to provide a first aqueous solution comprising reduced products and residual oxidizable organic compounds;
(c) contacting the first aqueous solution comprising reduced products and residual oxidizable organic compounds with a second planar anode and electrochemically oxidizing at least a portion of the organic compounds to provide a second aqueous solution comprising oxidation products; and
(d) contacting the second aqueous solution comprising oxidation products with a second planar cathode and electrochemically reducing at least a portion of the oxidation products to provide a second aqueous solution comprising reduced products and residual oxidizable organic compounds,
wherein the first planar anode and second planar cathode are positioned on a first surface, the first planar cathode and second planar anode are positioned on a second surface, and the first surface is parallel to and separated from the second surface to define a channel between the first planar anode and the second planar cathode on the first surface and the first planar cathode and second planar anode on the second surface, wherein the channel provides liquid communication between the anodes and cathodes.

15. The method of claim 1, comprising:
(a) introducing an aqueous solution comprising organic compounds into an electrochemical cell, wherein the cell comprises:
(i) one or more anodes for electrochemically oxidizing at least a portion of the organic compounds to provide oxidation products; and
(ii) one or more cathodes for electrochemically reducing at least a portion of the oxidation products,
wherein the one or more anodes and one or more cathodes are alternatively positioned on a surface to provide an array of interdigitated anodes and cathodes; and
(b) conducting the aqueous solution through the cell to provide an aqueous solution comprising reduced products and residual oxidizable organic compounds.

16. The method of claim 1, comprising:
(a) introducing an aqueous solution comprising organic compounds into an electrochemical cell, wherein the cell comprises:
(i) a first surface comprising
one or more anodes for electrochemically oxidizing at least a portion of the organic compounds to provide oxidation products, and
one or more cathodes for electrochemically reducing at least a portion of the oxidation products,
wherein the one or more anodes and one or more cathodes are alternately positioned on the surface to provide an array of interdigitated anodes and cathodes; and
(ii) a second surface comprising
one or more cathodes for electrochemically reducing at least a portion of the oxidation products, and
one or more anodes for electrochemically oxidizing at least a portion of the organic compounds to provide oxidation products;
wherein the one or more anodes on the first surface and the one or more cathodes on the second surface are alternately positioned on each surface to provide an array of interdigitated anodes and cathodes,
wherein the first surface is parallel to and separated from the second surface to define a channel between the interdigitated anodes and cathodes on the first surface and the interdigitated anodes and cathodes on the second surface, wherein the channel provides liquid communication between the anodes and cathodes; and
(b) conducting the aqueous solution through the cell to provide an aqueous solution comprising reduced products and residual oxidizable organic compounds.

17. The method of claim 1, wherein the anode generates oxidants.

18. The method of claim 1, wherein the anode is a metal oxide or a combination of metal oxides.

19. The method of claim 1, wherein the first anode or the surface of the first anode comprises carbon.

20. The method of claim 1, wherein the cathode is effective in reducing chlorate, perchlorate, haloacetic acids, halomethanes, haloethanes, and nitrosamines.

21-28. (canceled)
